(19) United States
(12) Patent Application Publication
(10) Pub. No.: US 2026/0062976 A1
(43) Pub. Date: Mar. 5, 2026

(54) METHOD FOR PREVENTING DOOR JAMMING AND SYSTEM FOR THE SAME

(71) Applicants: Hyundai Motor Company, Seoul (KR); Kia Corporation, Seoul (KR); PHA Co., Ltd., Daegu (KR)

(72) Inventors: Yeong Hyeon Han, Hwaseong-si (KR); Min Hyung Byun, Hwaseong-si (KR); Ji Ho Choi, Hwaseong-si (KR); Ja Sung Gu, Hwaseong-si (KR); Chang Seob Park, Hwaseong-si (KR); Won Woo Jeong, Daegu (KR); Seong Tae Hong, Suwon-si (KR)

(21) Appl. No.: 19/170,819

(22) Filed: Apr. 4, 2025

(30) Foreign Application Priority Data
Sep. 2, 2024 (KR) 10-2024-0118310

(51) Int. Cl. E05F 15/40

(52) U.S. Cl. CPC E05F 15/40; E05Y 2400/554; E05Y 2900/546

(57) ABSTRACT

A method for preventing door jamming can include classifying an entire section into at least two or more sections by measuring a variation amount of current for opening and closing an electric door, setting a reference for determining whether an event occurs and for reversing an opening and closing operation of the electric door, determining whether the event occurs during the opening and closing operation of the electric door based on the reference, checking whether an integrated amount of a variation amount of current for driving the electric door, which is generated by the event, is greater than a threshold value based on it being determined that the event exists; and stopping the opening and closing operation of the electric door based on the integrated amount being greater than the threshold value, and a system for the same.

### CROSS-REFERENCE TO RELATED APPLICATIONS

The present application claims priority to Korean Patent Application No. 10-2024-0118310, filed on Sep. 2, 2024, the entire contents of which is incorporated herein for all purposes by this reference.

### TECHNICAL FIELD

The present disclosure relates to a method for preventing door jamming caused by an electric door, and a system for the same.

### BACKGROUND

In general, as illustrated in FIG. 1, a tailgate is an opening and closing door installed at a rear of a station wagon, a van, or a recreational vehicle to accommodate luggage.

A tailgate 10 is installed to allow a driver to easily access a luggage compartment disposed in a vehicle. As the tailgate 10 is mounted to a rear of the vehicle, luggage may be conveniently loaded or unloaded, and passengers may enter or exit even from the rear of the vehicle.

In recent years, a power tailgate system capable of automatically opening and closing the gate by using a wired or wireless switch is installed on the tailgate 10.

In the power tailgate system, a logic is set to reverse a movement of the tailgate when a jamming accident occurs at the tailgate.

FIG. 2 illustrates a conventional logic for preventing the jamming accident with reference to a time-current graph of an electric actuator during an opening or closing operation. The conventional logic has a limitation that a reverse movement is not generated when a variation amount is less than a specific variation amount because the logic is simply based on a variation amount of an operation current of the tailgate.

That is, in FIG. 2, a recognition period from when the jamming occurs to when determining whether the jamming occurs is delayed. This is because determination is not performed when a current variation amount is less than a set determination reference current amount.

In particular, when dragging force that represents force of dragging a human body when jamming occurs during usage of the power tailgate of the vehicle is generated, the reverse movement may not be generated because a variation amount of operation current can be less than a predetermined level. This may cause body injury, inconvenience, and ultimately safety accidents.

### SUMMARY

The present disclosure relates to a method for preventing door jamming caused by an electric door such as a tailgate, and more particularly, a method for preventing door jamming, which is capable of preventing a safety accident by detecting dragging force although a variation of current for driving the electric door is insignificant, and a system for the same.

An embodiment of the present disclosure can solve the above-described limitations of a prior system.

An embodiment of the present disclosure can provide a method for preventing door jamming and a system for the same. More particularly, an embodiment of the present disclosure can provide a method for preventing a safety accident and improving reliability by detecting dragging force although a variation of current for driving an electric door is insignificant, and a system for the same.

An embodiment of the present disclosure can provide a method for preventing door jamming, and the method can include: classifying a time-current profile of an electric actuator for opening or closing an electric door into at least two sections; setting a reference for determining whether an event occurs; determining whether the event occurs during an opening or closing operation of the electric door based on the reference and a current applied to the electric actuator; checking, in response to a determination that the event occurs, whether an integrated amount over a predetermined time period in relation to the current is greater than a preset threshold value; and stopping the opening or closing operation of the electric door when it is checked that the integrated amount is greater than the threshold value.

In an embodiment, the integrated amount can be determined based on an integrated value of a variation of the current with respect to the reference.

In an embodiment, the method may further include reversing the opening or closing operation of the electric door.

In an embodiment, the event can include a door jamming.

In an embodiment, the setting the reference can include: obtaining the time-current profile depending on whether the event occurs; setting a reference current value for each of the at least two sections; and setting a target integrated amount for reversing the opening or closing operation of the electric door when the event occurs.

In an embodiment, the setting the reference may be performed at least two times to set an average value thereof as the reference.

In an embodiment, the determining whether the event occurs can include determining that the event occurs when the current is greater than the reference current value.

In an embodiment, the checking whether the integrated amount is greater than the preset threshold value can include: obtaining an integrated value of a magnitude variation of the current with respect to the reference current value; and determining that the event is caused by a soft object when an elapsed time for the integrated value to reach the target integrated amount is greater than or equal to a preset threshold time.

In an embodiment, the checking whether the integrated amount is greater than the preset threshold value can include determining that the event is caused by a rigid object when the elapsed time is within the preset threshold time.

In an embodiment, the checking whether the integrated amount is greater than the preset threshold value can include determining that the event is released when the current is maintained below the reference current value for a predetermined time.

In an embodiment of the present disclosure, a system for preventing door jamming can include: an electric door configured to be operated by an electric actuator; an electric door driving module configured to control the electric actuator in response to a door opening or closing request signal; a current measurement module configured to detect a current applied to the electric actuator; a integration module configured to obtain an integrated amount over a predetermined time period in relation to the current; and a control module configured to receive the current detected by the current measurement module and the integrated amount from the integration module to determine whether an event occurs during an opening or closing operation of the electric door and thereby control the electric door driving module, wherein the control module determines whether the event occurs during the opening or closing operation of the electric door based on a reference, checks whether the integrated amount is greater than a threshold value, and stops the opening or closing operation of the electric door when it is checked that the integrated amount is greater than the threshold value.

In an embodiment, the integration module can be configured to obtain the integrated amount based on an integrated value of a variation of the current with respect to the reference

In an embodiment, the event can include a door jamming.

In an embodiment, the reference can include a reference current value for each of at least two sections of a time-current profile of the electric actuator for opening or closing the electric door, and the reference current value can be determined based on the time-current profile obtained depending on whether the event occurs.

In an embodiment, the control module can be configured to set a target integrated amount for reversing the opening or closing operation of the electric door when the event occurs.

In an embodiment, the reference can be determined by an average value of a plurality of references.

In an embodiment, the control module can be configured to determine that the event occurs when the current is greater than the reference current value.

In an embodiment, the control module can be configured to receive an integrated value of a magnitude variation of the current with respect to the reference current value from the integration module and determine that the event is caused by a soft object when an elapsed time for the integrated value to reach the target integrated amount is greater than or equal to a preset threshold time.

In an embodiment, the control module can be configured to determine that the event is caused by a rigid object when the elapsed time is within the preset threshold time.

In an embodiment, the control module can be configured to determine that the event is released when the current is maintained below the reference current value for a predetermined time.

### BRIEF DESCRIPTION OF THE DRAWINGS

FIG. 1 is a view for explaining a structure and an opening or closing operation of a tailgate in an electric door.

FIG. 2 is a current graph based on a logic for preventing door jamming according to the related art.

FIG. 3 is a view for explaining areas corresponding to an opening or closing operation of a tailgate to explain concepts for applying a method for preventing door jamming caused by an electric door according to an embodiment of the present disclosure.

FIG. 4 is a block diagram illustrating a system for preventing door jamming caused by an electric door according to an embodiment of the present disclosure.

FIG. 5 is a flowchart for explaining a process of operating a system for preventing door jamming according to an embodiment of the present disclosure.

FIG. 6 is a current graph for reference setting of a system for preventing door jamming caused by an electric door according to an embodiment of the present disclosure.

FIG. 7A is a graph illustrating a current flow in an event generated by a soft object when applying a system for preventing door jamming according to an embodiment of the present disclosure.

FIG. 7B is a graph illustrating a current flow in an event generated by a rigid object when applying a system for preventing door jamming according to an embodiment of the present disclosure.

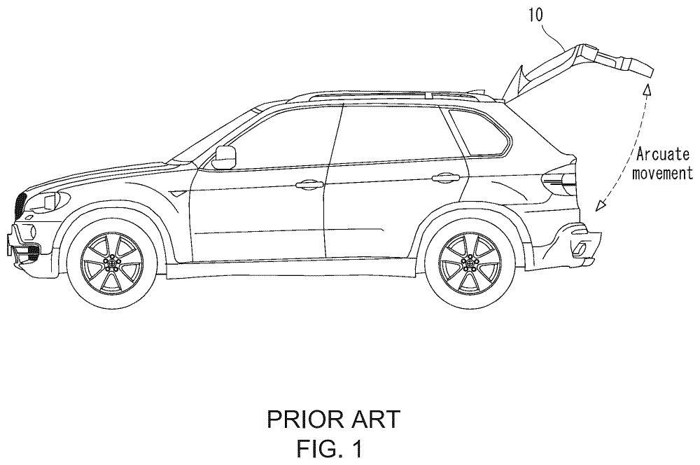

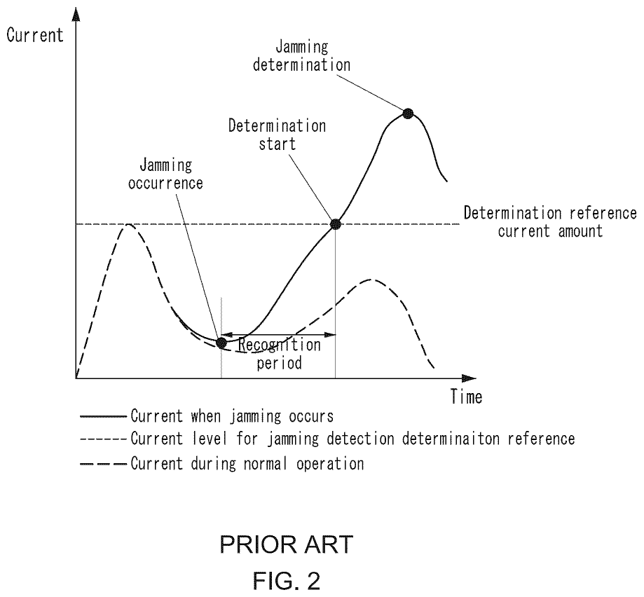

### DETAILED DESCRIPTION OF ILLUSTRATIVE EMBODIMENTS

Because the present disclosure can cover diverse modified embodiments, example embodiments are illustrated in the drawings and are described in the detailed description of the present disclosure. However, this does not necessarily limit scopes of the present disclosure to the example embodiments and it can be understood that the present disclosure can cover modifications, equivalents, and replacements within the ideas and technical scopes of the present disclosure.

In this specification, the suffixes “module” and “unit” can be used merely for nominal distinction between components and are not necessarily implying that the components are physically or chemically separated or that they can be separated.

It can be understood that although the terms of “first” and “second” can be used herein to describe various elements, these elements are not necessarily limited by these terms. These terms may be used solely to differentiate one component from another in name, and their sequential meanings can be understood through the context of the description rather than necessarily by the names themselves.

The term “and/or” can be used to include all possible combinations of the listed items. For example, “A and/or B” includes all three cases of “A”, “B”, and “A and B”.

It can be understood that when an element is referred to as being “connected to” or “engaged with” another element, it can be directly connected to the other element, or intervening elements may also be present.

In the following description, technical terms can be used for explaining a specific example embodiment while not necessarily limiting scopes of the present disclosure. Terms of a singular form may include plural forms unless referred to the contrary. The meaning of ‘include’ or ‘comprise’ specifies a property, a region, a fixed number, a step, a process, an element, and/or a component but does not exclude other properties, regions, fixed numbers, steps, processes, elements, and/or components.

Unless terms used in the present disclosure are defined differently, terms may be construed as meanings known to those skilled in the art. Terms such as terms that are generally used and have been in dictionaries can be construed as having meanings matched with contextual meanings in the art, for example.

Hereinafter, a method for preventing door jamming according to an example embodiment of the present disclosure, and a system for the same, will be described with reference to the accompanying drawings.

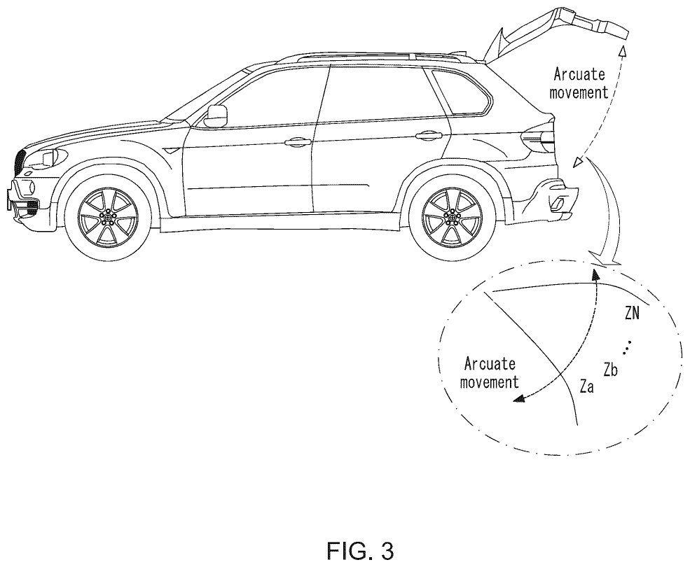

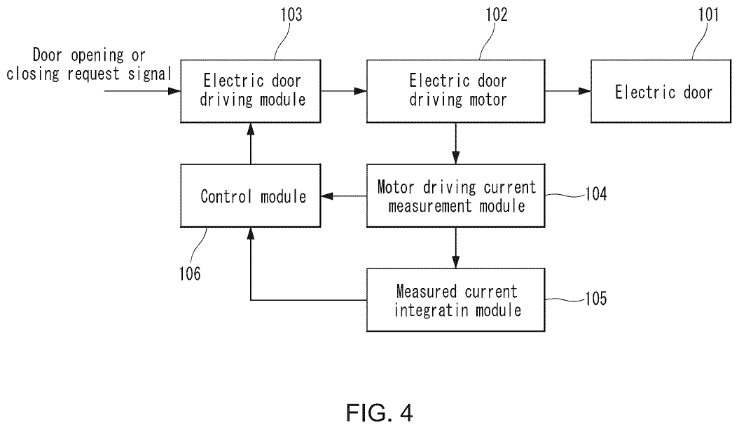

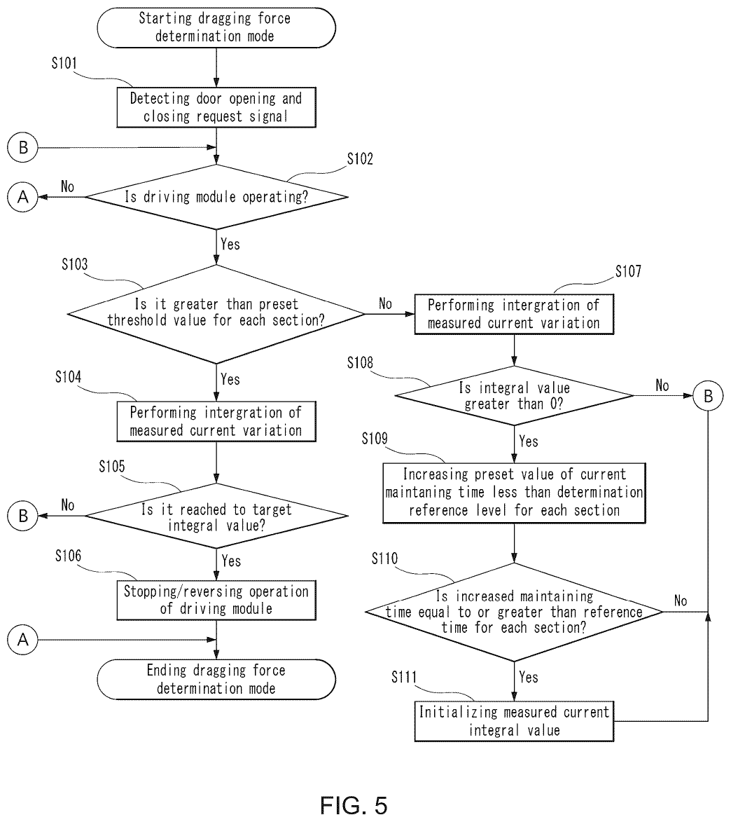

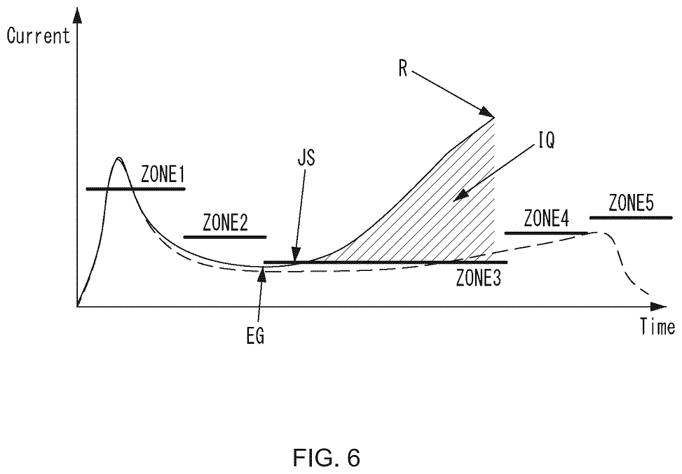

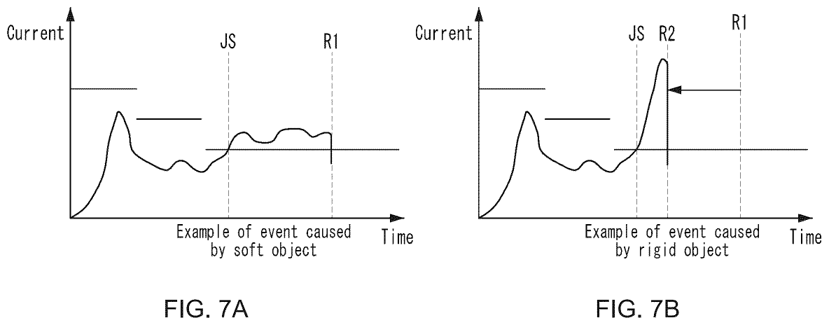

FIG. 3 is a view for explaining areas corresponding to opening or closing movements of a tailgate to explain concept for applying a method for preventing door jamming caused by an electric door according to an embodiment of the present disclosure. FIG. 4 is a block diagram illustrating a system for preventing door jamming caused by an electric door according to an embodiment of the present disclosure. FIG. 5 is a flowchart for explaining a process of operating a system for preventing door jamming according to an embodiment of the present disclosure. FIG. 6 is a current graph for reference setting of a system for preventing door jamming caused by an electric door according to an embodiment of the present disclosure. FIG. 7A is a graph illustrating a current flow in an event generated by a flexible object (or soft object) when applying a system for preventing door jamming according to an embodiment of the present disclosure. FIG. 7B is a graph illustrating a current flow in an event generated by a rigid object when applying a system for preventing door jamming according to an embodiment of the present disclosure.

An operating area of the door can be divided into a plurality of areas as illustrated in FIG. 3 to apply a method for preventing door jamming caused by an electric door according to an embodiment of the present disclosure.

FIG. 3 shows a tailgate performing an arcuate movement as an example. However, an embodiment of the present disclosure is not necessarily limited thereto.

As illustrated in FIG. 3, the operating area of an electric door can be divided into a plurality of areas, and, based on the plurality of areas, an example system to which a method for preventing door jamming caused by the electric door can be applied according to an embodiment of the present disclosure is shown in FIG. 4.

Referring to FIG. 4, a system for preventing door jamming caused by an electric door according to an embodiment of the present disclosure can include: an electric door 101 operating by driving force of an electric door driving motor 102; an electric door driving module 103 that can control the electric door driving motor 102 in response to a door opening or closing request signal (e.g., received from outside the system); a motor driving current measurement module 104 that can detect driving current according to an operation of the electric door driving motor 102; a measured current integration module 105 that can integrate a magnitude variation amount of the driving current detected by the motor driving current measurement module 104; and a control module 106 that can receive the driving current detected by the motor driving current measurement module 104 and receive an integral value from the measured current integration module 105 to determine whether an event occurs according to the opening or closing operation of the electric door 101, thereby controlling an operation of the electric door driving module 103.

Each of the above-described modules may include a processor, possibly in combination with a memory that stores programs for performing respective functions where the processor(s) execute the programs. The memories of the respective modules may be integrated into one or more memories, and the processors may be integrated into one or more processors.

The processor may include semiconductor integrated circuits and/or electronic elements that perform at least one or more of comparisons, determinations, calculations, and decisions to achieve programmed functions. For example, the processor may be a computer, a microprocessor, CPU, ASIC, an electronic circuitry (logic circuits), or a combination thereof.

Also, the memory, i.e., computer readable recording medium, includes all sorts of data storage devices that store computer readable data. For example, the computer readable recording medium may include at least one of a flash memory type, hard disk type, micro type, card type (e.g., secure digital (SD) card) or eXtream digital (XD) type memory and a random access memory (RAM), static RAM (SRAM), read-only memory (ROM), programmable ROM (PROM), electrically erasable PROM (EEPROM), magnetic RAM (MRAM), magnetic disk, or optical disk type memory.

These recording media may be electrically connected to the processor, and the processor may read data from and write data to the recording media. The recording media and the processor may be integrated with each other or physically separated from each other.

The operating area of the door illustrated in the FIG. 3 can be divided into a plurality of areas Za, Zb, and ZN by using the system for preventing door jamming caused by an electric door according to an embodiment of the present disclosure, and a pre-process for preventing the door jamming will be descried based on the plurality of areas.

First, the control module 106 can measure the current for opening or closing the electric door 101 based on whether an event occurs. The current during the opening or closing process of the electric door 101 without an event can be measured by the motor driving current measurement module 104. This process can be repeated a set, selected, or predetermined number of times, and an average value thereof can be set as a reference.

Also, as described above, when an event occurs and a jammed object is present, the system can distinguish whether the object is soft or rigid, measurement can be repeated a set, selected, or predetermined number of times, and the average value thereof can be set as a reference.

As described above, the measurement process can be performed in advance based on whether the event occurs. After measuring the current during the opening or closing process of the electric door 101, a total section of the operation can be divided into at least two sections (divided into N sections in FIG. 3) based on an inclination change point (or a preset environment near an inflection point) of the measured current. Also, a determination reference current value for determining the classified sections can be calculated or set for the classified sections.

When the event occurs, a target integrated amount for reversing the opening or closing operation of the electric door 101 can be set. Here, the measurement can be repeated a set, selected, or predetermined number of times, and an average value can be set.

When the reference values are set through the above-described processes, an operation process can be performed as illustrated in FIG. 5.

FIG. 5 is a flowchart for explaining a process of operating a system for preventing door jamming caused by an electric door according to an embodiment of the present disclosure, as in FIG. 4 for example. The operating process will be described below.

In operation S101, the electric door driving module 103 can detect whether a door opening or closing request signal is received (e.g., received from outside the system). In operation S102, the control module 106 can determine whether the electric door driving module 103 is operating through the motor driving current measurement module 104. That is, when the electric door driving module 103 is operating, the electric door driving motor 102 can perform or can be required to perform a forward or reverse rotation. Accordingly, current required for driving the motor can be measured and set as the reference.

When it is determined that the electric door driving module 103 is operating in operation S102, operation S103 can be performed to determine whether the current required for driving the motor is greater than a preset threshold value (reference value) for each section.

Here, the reference for determination in operation S103 can be as illustrated in FIG. 6. In the FIG. 6, a graph expressed by a dotted line can represent a driving current when an event does not occur, a graph expressed by a solid line can represent a driving current when the event occurs, and a reference line expressed by a bold solid line can represent an event determination reference current value for determining whether the event occurs in each zone (ZONE1 to ZONE5: if divided into five areas, as in the example of FIG. 6) to distinguish the operating process of the door.

Also, in FIG. 6, a point marked as EG can represent a time point at which a jamming event substantially occurs, a point marked as JS can represent a time point at which the jamming event begins to be recognized. Also, a point marked as R can represent a time point at which the jamming event occurs, and an integrated amount marked as IQ can reach the target integrated amount.

Thus, in operation S103, when the event occurs in an arbitrary section (e.g., the event occurs in ZONE3 in the example of FIG. 6) and current exceeding the preset threshold value (reference value) is detected, operation S104 can be performed to perform measured current integration through the measured current integration module 105.

In operation S105, it can be determined whether the integrated value (e.g., indicated by reference number IQ in the example of FIG. 6) performed in the process of operation S104 reaches the target value.

When it is determined in operation S105 that the integrated value (e.g., indicated by reference number IQ in the example of FIG. 6) performed in the process of operation S104 reaches the target value, the control module 106 can control the electric door driving module 103 to stop the opening/closing operation of the electric door 101 and reverse an operating direction to release the event.

On the other hand, when the current required for driving the motor exceeding the preset threshold value (reference value) for each section is not measured, but reaches the threshold value (reference value) in operation S103, operation S107 can be performed to perform the measured current integration through the measured current integration module 105.

While performing the measured current integration through the measured current integration module 105 in operation S107, whether the integrated amount is greater than 0 can be determined in operation S108. When the integrated amount is greater than 0, the event occurs, but an impact on the operation of the electric door 101 can be insignificant. That is, this can represent that the event occurs in a slippery and soft material or represents a malfunction.

Thus, as described above, when it is determined in operation S108 that the integrated value is greater than 0, operation S109 can be performed to add a time for maintaining the current less than the determination reference level as much as a preset time.

Here, when the current below the determination reference level is maintained for a set, selected, or predetermined time in operation S109, this may represent that the event occurs in a slippery and soft material or may represent a malfunction as described above. To check this, a checking time for each section can be added as much as the preset time.

Because this time addition may not be added limitlessly, it can be determined in operation S110 whether the increased maintenance time is greater than the reference time for each section. When it is true, operation S111 can be performed to initialize the integrated value calculated in operation S107. Thus, this can represent that the event occurs in a slippery and soft material (e.g., paper) or can represent a malfunction, and does not affect the operation of the electric door. That is, it can be determined that the event is released.

FIG. 7A is a graph illustrating a current flow an event generated by a soft object when applying a system for preventing door jamming caused by an electric door according to an embodiment of the present disclosure. FIG. 7B is a graph illustrating a current flow an event generated by a rigid object when applying a system for preventing door jamming caused by an electric door according to an embodiment of the present disclosure. Reference numeral R1 can represent a reverse time point in an event caused by a soft object, and reference numeral R2 can represent a reverse time point in an event caused by a rigid object.

As illustrated in the examples of FIGS. 7A and 7B, because the jamming can be determined when the target integrated amount is satisfied by performing integration for acting force (current level) for a determination section, when a determination is performed on acting force (current level) having a relatively small magnitude, a time required for completing determination can increase. Thus, it can be determined that the malfunction may be reduced.

Although an existing jamming determination logic is not necessarily used, it can be expected that the corresponding logic may determine whether general jamming occurs and whether dragging force occurs.

According to an embodiment of the present disclosure, a reverse timing can be adjusted according to a degree of applied force because the reverse movement can be generated when the integrated value of the current satisfies the target value.

Thus, as more strong force is applied (more rigid object is applied), the reverse movement can be quickly generated. Thus, it can be expected that a malfunction case caused by current close to the determination level can be reduced due to the increased determination time.

According to an embodiment of the present disclosure, in a method for preventing door jamming and a system for the same, as the jamming of a person and the jamming of an object is distinguished, when a person is jammed, the dragging force may be detected although the current for driving the electric door is insignificant. Thus, using an embodiment of the present disclosure, reliability for preventing a safety accident may be improved.

Although embodiments have been described with reference to a number of illustrative example embodiments thereof, it can be understood that numerous other modifications and embodiments can be devised by those skilled in the art that can fall within the spirit and scopes of the present disclosure. It can be understood that various features of the different embodiments can be combined. More particularly, various variations and modifications are possible in the component parts and/or arrangements of the subject combination arrangement within the scopes of the disclosure, the drawings, and the appended claims. In addition to variations and modifications in the component parts and/or arrangements, alternative uses also can be apparent to those skilled in the art.

What is claimed is:

1. A method for preventing door jamming, the method comprising:
classifying a time-current profile of an electric actuator for opening or closing an electric door into at least two sections;
setting a reference for determining whether an event occurs;
determining whether the event occurs during an opening or closing operation of the electric door based on the reference and a current applied to the electric actuator;
checking, in response to a determination that the event occurs, whether an integrated amount over a first time period in relation to the current is greater than a threshold value; and
stopping the opening or closing operation of the electric door based on the integrated amount being greater than the threshold value.

2. The method of claim 1, further comprising determining the integrated amount based on an integrated value of a variation of the current with respect to the reference.

3. The method of claim 1, further comprising reversing the opening or closing operation of the electric door.

4. The method of claim 1, wherein the event includes a door jamming.

5. The method of claim 4, wherein the setting of the reference comprises:
obtaining the time-current profile depending on whether the event occurs;
setting a reference current value for each of the at least two sections; and
setting a target integrated amount for reversing the opening or closing operation of the electric door based on the event occurring.

6. The method of claim 5, wherein the setting of the reference is performed at least two times to set an average value thereof as the reference.

7. The method of claim 5, wherein the determining whether the event occurs comprises determining that the event occurs based on the current being greater than the reference current value.

8. The method of claim 7, wherein the checking whether the integrated amount is greater than the threshold value comprises:
obtaining an integrated value of a magnitude variation of the current with respect to the reference current value; and
determining that the event is caused by a soft object based on an elapsed time for the integrated value to reach the target integrated amount being greater than or equal to a first threshold time period.

9. The method of claim 8, wherein the checking whether the integrated amount is greater than the threshold value further comprises determining that the event is caused by a rigid object based on the elapsed time being within the first threshold time period.

10. The method of claim 8, wherein the checking whether the integrated amount is greater than the threshold value further comprises determining that the event is released based on the current being maintained below the reference current value for a second time period.

11. A system for preventing door jamming, the system comprising:
an electric door configured to be operated by an electric actuator;
an electric door driving module configured to control the electric actuator based on a door opening or closing request signal;
a current measurement module configured to detect a current applied to the electric actuator;
a integration module configured to obtain an integrated amount over a first time period in relation to the current; and
a control module configured to receive the current detected by the current measurement module and the integrated amount from the integration module to determine whether an event occurs during an opening or closing operation of the electric door and thereby control the electric door driving module, wherein the control module is configured to determine whether the event occurs during the opening or closing operation of the electric door based on a reference, check whether the integrated amount is greater than a threshold value, and stop the opening or closing operation of the electric door based on the integrated amount being greater than the threshold value.

12. The system of claim 11, wherein the integration module is further configured to obtain the integrated amount based on an integrated value of a variation of the current with respect to the reference.

13. The system of claim 11, wherein the event includes a door jamming.

14. The system of claim 13, wherein the reference includes a reference current value for each of at least two sections of a time-current profile of the electric actuator for opening or closing the electric door, the reference current value being determined based on the time-current profile obtained depending on whether the event occurs.

15. The system of claim 14, wherein the control module is further configured to set a target integrated amount for reversing the opening or closing operation of the electric door based on the event occurring.

16. The system of claim 15, wherein the reference is determined by an average value of a plurality of references.

17. The system of claim 15, wherein the control module is further configured to determine that the event occurs based on the current being greater than the reference current value.

18. The system of claim 17, wherein the control module is further configured to receive an integrated value of a magnitude variation of the current with respect to the reference current value from the integration module and determine that the event is caused by a soft object based on an elapsed time for the integrated value to reach the target integrated amount being greater than or equal to a threshold time.

19. The system of claim 18, wherein the control module is further configured to determine that the event is caused by a rigid object based on the elapsed time being within the threshold time.

20. The system of claim 18, wherein the control module is further configured to determine that the event is released based on the current being maintained below the reference current value for a second time period.
